(19) United States
(12) Patent Application Publication
(10) Pub. No.: US 2011/0122132 A1
(43) Pub. Date: May 26, 2011

(54) APPARATUS AND METHOD OF MANAGING OBJECTS AND EVENTS WITH VECTOR-BASED GEOGRAPHIC INFORMATION SYSTEM

(75) Inventors: Geon Lyang KIM, Daejeon (KR); Beom Hwan Chang, Daejeon (KR); Chi Yoon Jeong, Daejeon (KR)

(73) Assignee: ELECTRONICS AND TELECOMMUNICATIONS RESEARCH INSTITUTE, Daejeon (KR)

(21) Appl. No.: 12/782,891

(22) Filed: May 19, 2010

(30) Foreign Application Priority Data
Nov. 25, 2009 (KR) 10-2009-0114752

(51) Int. Cl. G08B 5/22; G06T 17/00

(52) U.S. Cl. 345/420

(57) ABSTRACT

Provided are an apparatus and method of managing objects and events for easily enabling intuitive management and the recognition of cases in linkage with geographic information. The apparatus links objects and events to geographic information with a vector-based GIS to display them on a vector-based digital map, thereby providing an intuitive and realistic interface to a manager. Accordingly, the apparatus can display a more accurate location than an image-based map, and can select a kind of map information that is desired by a user to configure a map screen.

### CROSS-REFERENCE TO RELATED APPLICATIONS

This application claims priority under 35 U.S.C. §119 to Korean Patent

Application No. 10-2009-0114752, filed on Nov. 25, 2009, in the Korean Intellectual Property Office, the disclosure of which is incorporated herein by reference in its entirety.

### TECHNICAL FIELD

The following disclosure relates to an apparatus and method of managing objects and events with vector-based Geographic Information System (GIS), and in particular, to an apparatus and method for easily enabling intuitive management and the recognition of situation through a digital map.

### BACKGROUND

Conventional vehicle tracking system provides service by linking the object of a specific attribute to geographic information and presenting it on a map. Such an apparatus may be only used in a specific field, and consequently, if an operation environment is changed even a little, the apparatus should be reconfigured or modified.

Moreover, when linking object and event information to geographic information, it displays an object or an event on an image as an icon representing one map or a logical space and requests a manager to directly select each location. The each location set by the manager is stored in a database and thereafter is used for mapping with geographic information. At this point, however, since information stored in the database is the relative location of a specific map or image instead of an actual physical location, it needs to set again all locations when an image to be used as a background is changed.

In displaying geographic information, since a method using one image has limitations in the number of representable objects, other methods have been developed which topographically configure a plurality of images to display geographic information. However, since such a method configures an image to have only a three-stage layer e.g. country-city-district, it cannot provide a realistic screen through the manipulation (zoom-in/zoom-out) of a user due to the limitations of the precision of images. Moreover, since the method provides all the same information of images to a user in image characteristic, it may provide information irrelevant to a range of information that is desired by the user.

### SUMMARY

In one general aspect, an apparatus of managing objects and events with vector-based Geographic Information System (GIS) includes: an object management unit generating and managing objects to be linked with geographic information by using a vector-based GIS according to input object types; and an event processing unit receiving and processing an event associated with the object.

In another general aspect, a method of managing objects and events with vector-based GIS includes: generating objects to be linked with geographic information by using a vector-based GIS according to input object types; managing the generated objects; and receiving and managing an event associated with the object.

In another general aspect, a computer-readable storage medium, which stores a program code for executing a method of managing objects and events with vector-based GIS, executes: generating objects to be linked with geographic information by using a vector-based GIS according to input object types; managing the generated objects; and receiving and managing an event associated with the object.

Other features and aspects will be apparent from the following detailed description, the drawings, and the claims.

### BRIEF DESCRIPTION OF THE DRAWINGS

FIGURE 1 is a block diagram illustrating an apparatus of managing objects and events with vector-based GIS according to an exemplary embodiment.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness. The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

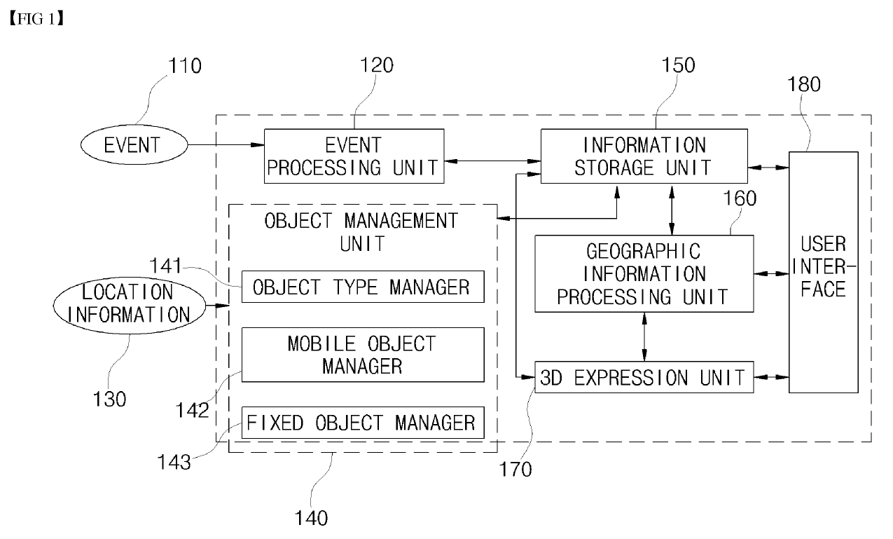

Hereinafter, an apparatus of managing objects and events with vector-based GIS according to an exemplary embodiment will be described with reference to FIGURE 1. FIGURE 1 is a block diagram illustrating an apparatus of managing objects and events with vector-based GIS according to an exemplary embodiment.

Referring to FIGURE 1, an apparatus of managing objects and events with vector-based GIS according to an exemplary embodiment includes an event processing unit 120, an object management unit 140, an information storage unit 150, a geographic information processing unit 160, a Three-Dimensional (3D) expression unit 170, and a user interface 180.

The event processing unit 120 receives and processes an object-related event 110.

The event processing unit 120 extracts data necessary for the event 110 that is received from the outside, and stores the extracted data in the information storage unit 150. The event processing unit 120 may also store event-related log information for the convenience of a user in accordance with event statistics.

Herein, the event 110 is data associated with an object. For example, when communication equipment in networks is the object, the event 110 may include traffic data, which is generated in networks, such as an Internet Protocol (IP) address and a port number, and alert data that is generated in security equipment such as firewalls and intrusion detectors.

The object management unit 140 includes an object type manager 141, a mobile object manager 142, and a fixed object manager 143. The object management unit 140 generates and manages objects to be linked with GIS-based geographic information according to input object types.

The object management unit 140 generates and manages objects that are inputted through the user interface 180 by a user, i.e., corresponding to respective defined object types.

The object type includes an icon to be displayed on a map, whether to move the object type (for example, mobile type or fixed type) to be defined, the name and value (for example, character, column, integer, and IP address) of an attribute configuring the object type, the number of values included in one attribute, etc.

The object type manager 141 stores an input object type in the information storage unit 150, and determines whether a user changes the stored object type. When the stored object type is changed as the result of determination, the object type manager 141 transfers the determination result to the object management unit 140.

When the object management unit 140 receives the determination result, indicating that the object type is to be changed, from the object type manager 141, it deletes an object which is managed in correspondence with the object type so that the object type may be changed by the user.

The object management unit 140 generates a mobile object and a fixed object according to defined object types. For example, the object management unit 140 may generate a mobile object when an object type inputted from the user is a mobile object, and it may generate a fixed object when the object type inputted from the user is a fixed object.

The mobile object manager 142 manages the generated mobile object, receives the location information of the mobile object, and stores the received location information in the information storage unit 150 in correspondence with the mobile object.

The mobile object manager 142 receives the location information of a desired object for all mobile objects belonging to an object type, and manages the route information of the mobile object. When the location of the mobile object is moved, the mobile object manager 142 moves a center point in accordance with the moved location.

Herein, location information 130 includes the latitude and longitude values of the mobile object. When providing the 3D expression function of a building unit, the location information 130 also includes a height value.

The fixed object manager 143 manages the fixed object.

The object management unit 140 modifies or deletes the generated object according to the manipulation of the user.

For example, when an object type is inputted by the user, the object type manager 141 stores the input object type. The object management unit 140 generates an object according to the stored object type, and modifies or deletes the generated object according to the manipulation of the user.

The geographic information processing unit 160 links the generated object or the received event 110 to geographic information and provides the geographical location of the event 110 or object.

For providing the geographic location information of the event 110 or object to the user, the geographic information processing unit 160 links geographic information and event information, and links the geographic information and object information. The geographic information processing unit 160 provides the linkage results in a map type to the user interface 180. When the user manipulates a screen like zoom-in/zoom-out, desires to select and view map information, and searches a desired area to move to the searched area, the geographic information processing unit 160 processes and provides geographic information for the convenience of the user.

The information storage unit 150 may store event information, object information and geographic information, and may have a format such as a database (DB) or a file.

When the object or the event 110 is disposed in a specific building and the building is selected, the 3D processing unit 170 processes the selected building to be three-dimensionally displayed and expresses the processed building through the user interface 180.

In mapping the event 110 or object linked to the geographic information on a map, the 3D processing unit 170 expresses the locations of the fixed/mobile object and event 110, which three-dimensionally exist in a building, through the user interface 180 when intending to provide the accurate and detailed screen of a building unit to the user.

As described above, the apparatus of managing objects and events with vector-based GIS according to an exemplary embodiment links an object and an event to geographic information with a vector-based GIS, and displays the object and event linked to the geographic information on a vector-based digital map, thereby providing the intuitive and realistic geographical locations of the object and event. Particularly, since the apparatus of managing objects and events according to an exemplary embodiment can three-dimensionally express the locations of the object and event in building units on a map screen, it can provide accurate and detailed location information. Moreover, the apparatus of managing objects and events according to an exemplary embodiment can select geographic information to configure a map screen.

The invention can also be embodied as computer readable codes on a computer-readable storage medium. The computer-readable storage medium is any data storage device that can store data which can be thereafter read by a computer system. Examples of the computer-readable storage medium include ROMs, RAMs, CD-ROMs, DVDs, magnetic tapes, floppy disks, registers, buffers, optical data storage devices, and carrier waves (such as data transmission through the Internet). The computer-readable storage medium can also be distributed over network coupled computer systems so that the computer readable codes are stored and executed in a distributed fashion. Also, functional programs, codes, and code segments for accomplishing the present invention can be easily construed by programmers skilled in the art to which the present invention pertains.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus of managing objects and events with vector-based Geographic Information System (GIS) comprising:
an object management unit generating and managing objects to be linked with geographic information by using a vector-based GIS according to input object types; and
an event processing unit receiving and processing an event associated with the object.

2. The apparatus of claim 1, further comprising a geographic information processing unit linking the generated object or the received event with the geographic information and providing the geographical location of the object or event. 15

3. The apparatus of claim 2, further comprising a Three-Dimensional (3D) processing unit processing a selected specific building to be three-dimensionally displayed when the provided object or event is disposed in the specific building and the building is selected.

4. The apparatus of claim 2, wherein the geographic information processing unit processes the geographic information according to any one of a screen which is zoomed in/out according to manipulation of a user, area information selected from the screen and map information selected from the screen, and provides a geographical location of the object or event based on the processed geographic information.

5. The apparatus of claim 1, wherein the object type comprises any one of an icon of an object to be generated, whether to move, a name and value of an attribute configuring an object to be generated, and the number of values belonging to one attribute.

6. The apparatus of claim 5, wherein when the generated object is a mobile object, the object management unit receives location information of the mobile object, and stores the received location information in correspondence with the mobile object.

7. The apparatus of claim 1, wherein the event processing unit extracts necessary data from the received event, and stores the extracted data.

8. The apparatus of claim 1, wherein the event comprises traffic data which is generated in a network comprising an Internet Protocol (IP) address or a port number, and alert data which is generated in a firewall, an intrusion detector and security equipment.

9. The apparatus of claim 1, wherein:
the input object type is stored,
the object management unit determines whether the stored object type is changed by a user, and
when the stored object type is changed, the object management unit deletes an object which is managed in correspondence with the object type for the user to change an object type.

10. A method of managing objects and events with vector-based Geographic Information System (GIS) comprising:
generating objects to be linked with geographic information by using a vector-based GIS according to input object types;
managing the generated objects; and
receiving and managing an event associated with the object.

11. The method of claim 10, further comprising linking the generated object or the received event with the geographic information and providing the geographical location of the object or event.

12. The method of claim 11, further comprising three-dimensionally displaying a selected specific building when the object or event is disposed in the specific building and the building is selected.

13. The method of claim 11, wherein the providing of the geographical location comprises:
processing the geographic information according to any one of a screen which is manipulated by a user, area information selected from the screen and map information selected from the screen; and
providing a geographical location of the object or event on the basis of the processed geographic information.

14. The method of claim 10, wherein the object type comprises any one of an icon of an object to be generated, whether to move, a name and value of an attribute configuring an object to be generated, and the number of values belonging to one attribute.

15. The method of claim 14, wherein the managing of the generated objects comprising:
receiving location information of the mobile object, when the generated object is a mobile object; and
storing the received location information in correspondence with the mobile object.

16. The apparatus of claim 10, wherein the receiving and managing of an event comprising:
extracting necessary data from the received event; and
storing the extracted data.

17. The apparatus of claim 10, wherein the event comprises traffic data which is generated in a network comprising an Internet Protocol (IP) address or a port number, and alert data which is generated in a firewall, an intrusion detector and security equipment.

18. The method of claim 10, wherein:
the input object type is stored, and
the managing of the generated objects comprises:
determining whether the stored object type is changed by a user; and
deleting an object which is managed in correspondence with the object type for the user to change an object type, when the stored object type is changed.

19. A computer-readable storage medium storing a program code for executing a method of managing objects and events with vector-based Geographic Information System (GIS), the computer-readable storage medium executing:
generating objects to be linked with geographic information by using a vector-based GIS according to input object types;
managing the generated objects; and
receiving and managing an event associated with the object.

20. The computer-readable storage medium of claim 19, wherein the computer-readable storage medium stores and executes the program code which is distributed to a computer system connected to a network and is read in a distributed scheme by a computer.
